(19) United States
(12) Patent Application Publication
(10) Pub. No.: US 2016/0152359 A1
(43) Pub. Date: Jun. 2, 2016

(54) PROCEDURE FOR THE MANUFACTURE OF VIALS FOR FLUID PRODUCTS, PARTICULARLY FOR MEDICAL, PHARMACEUTICAL, COSMETIC, FOOD PRODUCTS OR THE LIKE

(71) Applicant: LAMEPLAST S.P.A., Rovereto sul Secchia-Novi di Modena (MO) (IT)

(72) Inventor: Antonio FONTANA, Carpi (MO) (IT)

(21) Appl. No.: 14/904,099

(22) PCT Filed: Jul. 7, 2014
(86) PCT No.: PCT/IB2014/062920

§ 371 Date: Jan. 10, 2016

(30) Foreign Application Priority Data
Jul. 9, 2013 (IT) MO2013A000197

(51) Int. Cl. B65B 7/16; B65B 3/00; B65B 51/22; A61J 1/06

(52) U.S. Cl. CPC B65B 7/161; A61J 1/067; B65B 3/003; B65B 51/225; A61J 2205/30

(57) ABSTRACT

The procedure for the manufacture of vials for fluid products, particularly for medical, pharmaceutical, cosmetic, food products or the like, comprises the steps of:
forming at least a vial (1) having:
   at least a containment body (4) for at least a fluid product, the containment body (4) having a longitudinal direction (D), a first extremity (5) suitable for defining a dispensing mouth (6) of the fluid product and a second extremity (7) substantially tubular opposite the first extremity (5) and suitable for defining an introduction opening (8) of the fluid product having an edge (9); and
   at least a closing element (10) of the dispensing mouth (6);
filling the containment body (4) with the fluid product with the dispensing mouth (6) closed by the closing element (10);
sealing the introduction opening (8) by squeezing the edge (9) between at least two sealing elements (16) to define a sealed portion (17, 18) substantially plate-shaped;
applying information, data or logos (21) on the sealed portion (17, 18).

### TECHNICAL FIELD

The present invention relates to a procedure for the manufacture of vials for fluid products, particularly suitable for containing products used in the medical, pharmaceutical, cosmetic, food sector or the like.

### BACKGROUND ART

With particular reference to pharmaceutical and/or cosmetic industry the use is known of vials made of polymer material for the packaging of one or more doses of fluid, liquid or pasty products.

The known vials may be of the resealable or disposable type and generally comprise a containment body for containing a predetermined dose of product, with a substantially tubular and elongated shape, which has an extremity provided with a neck, on top of which is defined a dispensing mouth for the product.

The opposite extremity of the containment body has an opening adapted to the introduction of the product, which is closed after filling, e.g., by sealing.

Closing means, which are associable in a removable manner with the vials in correspondence to their neck, allow to clog the dispensing mouth.

The containment body and the closing means can be made separately, using forming techniques such as injection molding, and subsequently assembled together, or, alternatively, they can be made in a single body piece and subsequently separated by a user before use.

The containment body also has a pair of fins which are adapted to facilitate the grip of the vial by a user, and which extend, diametrically opposite one another, from the outer lateral surface of the containment body itself.

The known vials can be produced in single units or can be associated with one another in series to form a so-called “strip”; in the latter case, the fins of the containment bodies of two successive vials are temporarily associated with one another in correspondence to easily tearable connection lines with weakened section, allowing the separation of one vial from the other.

With particular reference to the closing means and their conformation, different types of vial are known according to different modes of use and realization.

A first type of known vials provides, e.g., the use of a closing element that, during molding, is made with a portion fixed to the vial neck along predetermined breaking areas, to clog the dispensing mouth.

In other words, the containment body and the closing element are made in a single body piece so that the dispensing mouth of the vial is initially closed and may be opened by tearing off the closing element from the containment body.

Eventually, the closing element may also comprise a cap seat, which is arranged opposite the portion initially fixed to the neck and which has a clogging body suitably sized to be introduced in the dispensing mouth.

In this case the vial is opened for the first time by detaching the closing element from the dispensing mouth in correspondence to the breaking areas and, after using the product, the vial may be sealed again by turning the closing element upside down and by fitting the cap seat on the neck, then positioning the clogging body within the dispensing mouth.

Vials of this type are shown in the patent document EP 0326529 B1.

A second type of resealable vials made in a single body piece comprises closing means having a clogging element, of the cap type or the like, fitted sealed within the dispensing mouth, and deformable or breakable elements that connect, without interruption, the closing means to the vial body.

Such deformable or breakable elements are adapted to signal to the user any possible product contamination due to any tampering and/or accidental opening of the product, thereby acting as a guarantee seal.

Vials of this type are shown in the patent document EP 2139659 B1.

Furthermore, a third type of vials is known, wherein the closing means and the containment body are made in separate pieces, subsequently assembled together.

The closing means of such vials generally comprise a handle having a clogging element, of the cap type or the like, which may be fitted sealed within the dispensing mouth, and an annular collar fixable coaxially and interlocking in correspondence to the neck of the containment body.

The handle is associated in a removable manner in correspondence to the outer surface of the collar by means of a suitable weakened area, made up, e.g., of pre-breaking lines, by tearable bridges, by reduced cross-sections or the like.

The handle, the collar and the cap are therefore made in a single body piece, separately from the containment body, and the collar is subsequently fixed to the neck by interlocking, with the cap closing the dispensing mouth.

Vials of this type are shown in the patent document EP 1289842 B1.

These known vials are however susceptible of further improvements.

In particular, due to European and U.S. standards being increasingly restrictive and stringent, the presence of product-related information is mandatory on each individual vial (instead of on the whole strip and in addition to those commonly indicated on the packaging and/or on additional leaflets).

This need is even greater in the case of strips composed of vials containing different products, wherein the comprehensiveness and clarity of information included in correspondence to each vial is essential.

The information, which may comprise e.g. information on the product dosage, the packaging and/or expiry date, or the like, is generally printed in correspondence to the gripping fins of the vials, by printing or application of labels or the like.

The increasing need to add as much information as possible, in a clearly legible manner, contrasts, on the other hand, to the presence of small surface portions that can be used in correspondence to the gripping fins.

In addition, the remaining portions of the vials are not generally useful for the inclusion of such information, due to the presence of special reliefs, shaping or edging.

To this is added that the law standards of some countries are even more restrictive for particular types of fluid product, such as those intended for oral administration, and require in these cases the information not being printed directly on the containment body of the product, to avoid that the ink may pass through the vial walls and pollute the fluid product, thus reducing even more the available surfaces.

To rule out at least in part these drawbacks the patent document WO 2007/107825 A2 and WO2007/107826 A2 teach to make vials having a substantially plate-shaped closing element on which an adhesive label is applied bearing the information required.

In this embodiment, however, the opening of the vial involves the removal of the closing element from the containment body and of the relative label applied on it, thus completely negating its utility.

In some circumstances, however, it is necessary that the information on the vials remains always visible and identifiable by the user even after opening.

### DESCRIPTION OF THE INVENTION

The main aim of the present invention is to provide a procedure for the manufacture of vials for fluid products, particularly for medical, pharmaceutical, cosmetic, food products or the like, wherein it is possible to include all the product-related information required, in a clear and legible manner.

Another object of the present invention is to provide a manufacturing procedure allowing to manufacture vials for fluid products wherein the product-related information is not missed after opening the vial and still remains at the user's disposal.

Another object of the present invention is to provide a procedure for the manufacture of vials for fluid products, particularly for medical, pharmaceutical, cosmetic, food products or the like that allows to overcome the mentioned drawbacks of the prior art in the ambit of a simple, rational, easy and effective to use as well as low cost solution.

The above mentioned objects are achieved by the present procedure for the manufacture of vials for fluid products, particularly for medical, pharmaceutical, cosmetic, food products or the like, according to claim 1.

### BRIEF DESCRIPTION OF THE DRAWINGS

Other characteristics and advantages of the present invention will become more evident from the description of a preferred, but not exclusive, embodiment of a procedure for the manufacture of vials for fluid products, particularly for medical, pharmaceutical, cosmetic, food products or the like, illustrated as an indicative but not limitative example in the accompanying drawings in which:

FIG. 1 is an axonometric view illustrating the forming step provided by the procedure according to the invention;

FIG. 2 is an axonometric view illustrating the filling step provided by the procedure according to the invention;

FIG. 3 is an axonometric view illustrating the sealing step provided by the procedure according to the invention;

FIG. 4 is an axonometric view illustrating the application step provided by the procedure according to the invention.

### EMBODIMENTS OF THE INVENTION

With particular reference to these figures, with I, II, III, IV are indicated the steps of the procedure according to the invention.

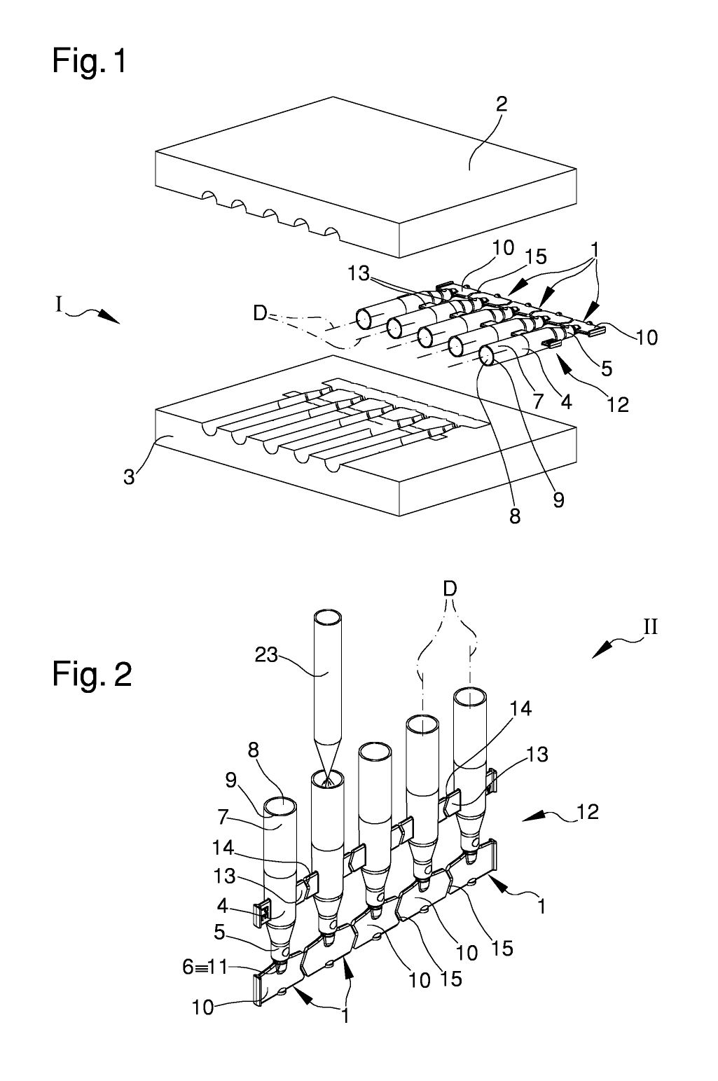

Step I of the procedure is shown in FIG. 1 and consists in forming at least a vial 1 for fluid products, particularly for medical, pharmaceutical, cosmetic, food products or the like.

In this respect, it is specified that in the present treatise the term “fluid products” does not only mean liquid products but also viscous products, e.g. in the state of paste and gel, and powder products, particularly very fine powders with huge smoothness.

Preferably, the step I is carried out by injection molding of plastic material inside a forming mold 2, 3.

The forming mold 2, 3 consists, e.g., in a first half-shell 2 and in a second half-shell 3 which are formed so as to shape the outer surfaces of vial 1, and in one or more inner cores, not shown in the illustrations, which are formed so as to shape the inner surfaces of vial 1.

The vial 1 comprises at least a containment body 4 for the fluid product.

The containment body 4 is shaped so as to have a substantially tube conformation which mainly extends along a longitudinal direction D.

The containment body 4 has:
a first extremity 5 suitable for defining a dispensing mouth 6 for the outflow of the fluid product, and
a second extremity 7, substantially tubular, that is opposite the first extremity 5 and is suitable for defining an introduction opening 8, having an edge 9, for the filling of the containment body 4 with the fluid product.

The vial 1 also comprises a closing element 10 that allows to close the dispensing mouth 6.

In the particular embodiment shown in the illustrations, the containment body 4 and the closing element 10 are made integral in a single body piece and are joined to one another in correspondence to a breakable stretch 11.

In this case, therefore, the dispensing mouth 6 and the breakable stretch 11 coincide; the dispensing mouth 6, in fact, is initially made closed and is opened only when using the vial 1 by tearing off the closing element 10 from the containment body 4.

For this purpose, the closing element 10 is substantially plate-shaped so as to define an operating key which can easily be grasped by the user to facilitate the removal by tearing off of the closing element 10 from the containment body 4.

Alternative embodiments of the present invention are however possible wherein the containment body 4 and the closing element 10 are initially separated from one another and are assembled only after forming.

Usefully, during step I several vials 1 are formed at the same time.

The step I, in fact, comprises forming a strip 12 of vials 1 wherein each vial 1 comprises at least a spacing fin 13 which extends from a respective containment body 4 and which is associated with at least a spacing fin 13 of an adjacent vial 1 along a first area with weakened section 14.

In other words the half-shells 2, 3 are shaped so that the first areas with weakened section 14 allow the spacing fins 13 of the strip 12 to keep the vials 1 joined together until use, when the user separates the vials 1 by tearing off the first areas with weakened section 14.

Usefully, the vials 1 of the strip 12 are joined together also in correspondence to the second areas with weakened section 15 placed between the closing elements 10; the operating key 10 of each vial 1, in fact, extends substantially parallel to the spacing fins 13 and joins to at least an operating key 10 of the adjacent vials 1.

At the exit from the half-shells 2, 3, the strip 12 is in the form of a semi-finished product grouping a plurality of vials 1 arranged side by side wherein:
the longitudinal directions D of vials 1 are arranged substantially parallel to one another on the same lying plane;
on the same side of the strip 12 are arranged the first extremities 5 of vials 1 and the closing elements 10;
on the opposite side of the strip 12 are arranged the second extremities 7 of vials 1 and the introduction openings 8.

Step II of the procedure is shown in FIG. 2 and consists in filling the containment bodies 4 of vials 1 with the fluid product, an operation that can be performed by means of an injector 23.

In this regard it should be noted that, during filling, the dispensing mouths 6 of vials 1 are closed by the closing elements 10.

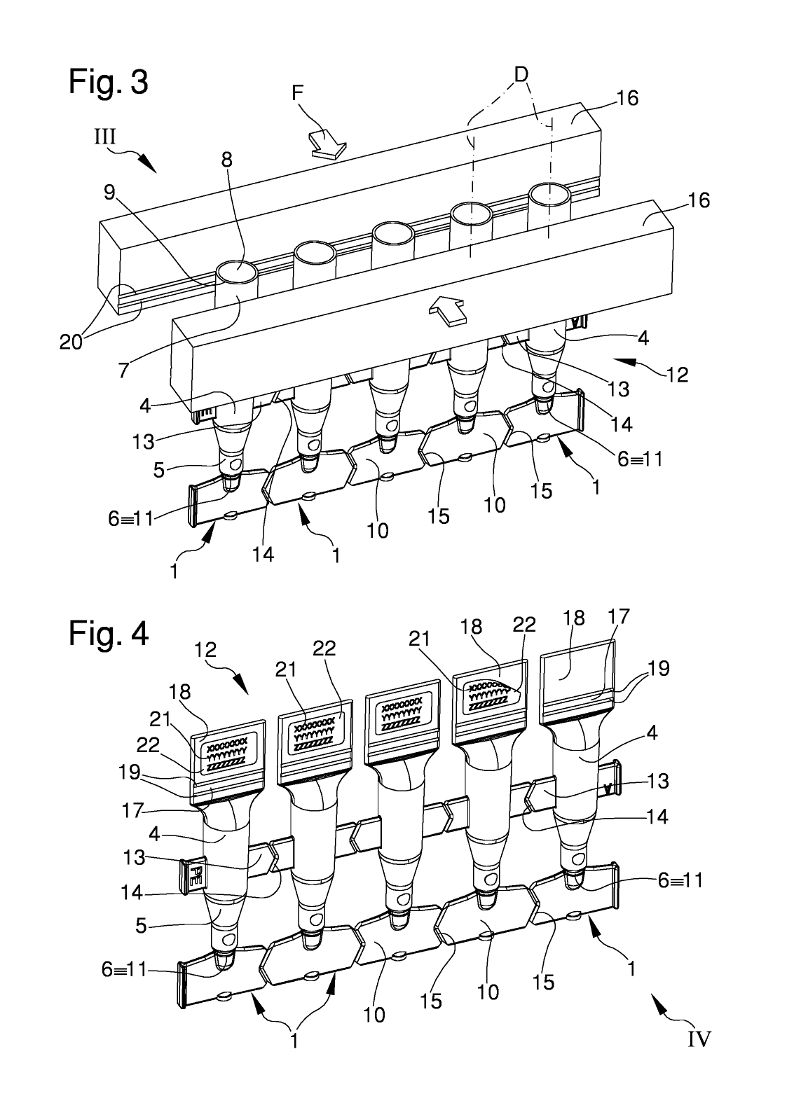

Step III of the procedure is shown in FIG. 3 and consists in sealing the introduction openings 8 of vials 1.

This operation occurs by squeezing the edges 9 of the introduction openings 8 between at least two sealing elements 16 to define, for each vial 1, a substantially plate-shaped sealed portion 17, 18.

Sealing is hot and/or ultrasound sealing; in both cases, the plastic material which makes the vials 1 is heated in correspondence to the sealing elements 16, softening the material and determining the adhesion thereof when the lips of the squeezed edges 9 come in mutual contact.

The sealing elements 16 consist e.g. in a pair of bars that squeeze the strip 12 in correspondence to the edges 9 of vials 1 along a direction F substantially transversal to the plane on which the strip 12 lies.

The sealed portions 17, 18 obtained this way extend substantially coplanar to the plane on which the strip 12 lies.

Conveniently, during sealing, at least a reinforcement rib 19, preferably two, is defined on one part of the sealed portions 17, 18.

The reinforcement ribs 19 are obtained thanks to corresponding grooves 20 formed on the sealing elements 16.

The reinforcement ribs 19 extend substantially at right angles to the longitudinal directions D of vials 1.

The sealed portions 17, 18 are split up into at least a first stretch 17, on which are defined the reinforcement ribs 19, and into at least a second stretch 18, without the reinforcement ribs 19 and adjacent to the first stretch 17.

The first stretch 17 is arranged in proximal position while the second stretch 18 is arranged in distal position; in this regard it is specified that within the present treatise the adjectives “proximal” and “distal” should be evaluated with respect to the position of the first extremities 5.

This means that the first stretch 17 of each sealed portion 17, 18, which is in proximal position, occupies the part of sealed portion 17, 18 closest to the first extremities 5 and, therefore, is arranged adjacent to the containment bodies 4.

The second stretch 18 of each sealed portion 17, 18, which instead is in distal position, occupies the part of sealed portion 17, 18 farthest from the first extremities 5 and, therefore, is arranged in a position opposite the closing elements 10.

Step IV of the procedure is shown in FIG. 4 and consists in applying information, data or logos 21 on the sealed portions 17, 18.

The information, data or logos 21 relate, e.g., to at least one of:
indications on the dosing of the fluid product;
indicative illustrations about the use of the fluid product;
indicative information about the type of the fluid product;
the expiry date of the fluid product.

Usefully, such information, data or logos 21 are applied on the second stretch 18 of the sealed portion 17, 18 which, being without the reinforcement ribs 19, can be used in a very practical and convenient manner for this purpose.

Step IV, e.g., consists in attaching at least a label 22 supporting the information, data, or logos 21 in correspondence to at least a face of the sealed portion 17, 18.

Alternatively, the information, data, or logos 21 can be printed directly on a face of the sealed portion 17, 18.

In this regard it is specified that, in the ambit of the present treatise, saying that the information, data or logos 21 are “printed directly on the sealed portion” means that the information, data or logos 21 are reproduced on the sealed portion 17, 18 without interposition of an intermediate support, as instead is the case with label 22.

For printing the information, data, or logos 21 directly on the sealed portion 17, 18, e.g., techniques of screen printing, marking, infill, or printing on plastic material can be employed.

It is clear, therefore, that at the end of the procedure, each vial 1 comprises:
the containment body 4, filled with the fluid product;
the closing element 10, in the closed position of the dispensing mouth 6; and
the sealed portion 17, 18 which closes the second extremity 7 of the containment body 4 and which supports the information, data or logos 21.

Similarly, it is clear that at the end of the procedure, the strip 12 comprises a plurality of vials 1, wherein each vial 1 has:
the containment body 4, filled with the fluid product;
at least a spacing fin 13, which extends from the containment body 4 and which is associated with a spacing fin 13 of an adjacent vial 1;
the closing element 10, in the closed position of the dispensing mouth 6; and
the sealed portion 17, 18 which closes the second extremity 7 of the containment body 4 and which supports the information, data, or logos 21.

1) Procedure for the manufacture of vials for fluid products, particularly for medical, pharmaceutical, cosmetic, food products or the like, wherein said procedure comprises the steps of:
forming at least a vial (1) having:
at least a containment body (4) for at least a fluid product, said containment body (4) having a longitudinal direction (D), a first extremity (5) suitable for defining a dispensing mouth (6) of said fluid product and a second extremity (7) substantially tubular opposite said first extremity (5) and suitable for defining an introduction opening (8) of said fluid product having an edge (9); and
at least a closing element (10) of said dispensing mouth (6);
filling said containment body (4) with said fluid product with said dispensing mouth (6) closed by said closing element (10);
sealing said introduction opening (8) by squeezing said edge (9) between at least two sealing elements (16) to define a sealed portion (17, 18) substantially plate-shaped;
applying information, data or logos (21) on said sealed portion (17, 18).

2) Procedure according to claim 1, wherein said sealing comprises defining at least a reinforcement rib (19) onto a part of said sealed portion (17, 18), said sealed portion (17, 18) being split up into at least a first stretch (17) on which is defined said reinforcement rib (19) and into at least a second stretch (18) on which said information, data or logos (21) are applied.

3) Procedure according to claim 2, wherein said first stretch (17) is arranged in proximal position and said second stretch (18) is arranged in distal position.

4) Procedure according to claim 1, wherein said sealing is hot and/or ultrasound sealing.

5) Procedure according to claim 1, wherein said forming is by injection molding of plastic material inside a forming mold (2, 3).

6) Procedure according to claim 1, wherein said forming comprises forming a strip (12) of said vials (1) wherein each of said vials (1) comprises at least a spacing fin (13) which extends from a respective containment body (4) and which is associated with at least a spacing fin (13) of an adjacent vial (1) along a first area with weakened section (14).

7) Procedure according to claim 1, wherein said sealing comprises squeezing said strip (12) in correspondence to said edges of the vials (1) along a direction (F) substantially transversal to the plane on which said strip (12) lies.

8) Procedure according to claim 1, wherein said applying comprises attaching at least a label (22) supporting said information, data or logos, in correspondence to at least a face of said sealed portion (17, 18).

9) Procedure according to claim 1, wherein that said applying comprises printing said information, data or logos (21) directly onto at least a face of said sealed portion (17, 18).

10) Procedure according to claim 1, wherein said information, data or logos (21) comprise at least one of:
indications on the dosing of said fluid product;
indicative illustrations about the use of said fluid product;
indicative information about the type of said fluid product;
the expiry date of said fluid product.

11) Vial (1) for fluid products, particularly for medical, pharmaceutical, cosmetic, food products or the like, obtainable through the procedure according to claim 1, wherein said vial (1) comprises:
at least a containment body (4) for at least a fluid product, said containment body (4) having a longitudinal direction (D), a first extremity (5) suitable for defining a dispensing mouth (6) of said fluid product and a second extremity (7) substantially tubular opposite said first extremity (5);
at least a closing element (10) of said dispensing mouth (6); and
at least a sealed portion (17, 18) which closes said second extremity (7) and which supports information, data or logos (21).

12) Strip of vials (1) for fluid products, particularly for medical, pharmaceutical, cosmetic, food products or the like, obtainable through the procedure according to claim 1, wherein said strip comprises a plurality of vials (1) wherein each of said vials (1) comprises:
at least a containment body (4) for at least a fluid product, said containment body (4) having a longitudinal direction (D), a first extremity (5) suitable for defining a dispensing mouth (6) of said fluid product and a second extremity (7) substantially tubular opposite said first extremity (5);
at least a spacing fin (13) which extends from said containment body (4) and which is associated with at least a spacing fin (13) of an adjacent vial (1) along a first area with weakened section (14);
at least a closing element (10) of said dispensing mouth (6); and
at least a sealed portion (17, 18) which closes said second extremity (7) and which supports information, data or logos (21).
